(19) United States
(12) Patent Application Publication
(10) Pub. No.: US 2016/0063854 A1
(43) Pub. Date: Mar. 3, 2016

(54) HOME AUTOMATION CONTROL USING CONTEXT SENSITIVE MENUS

(71) Applicant: ECHOSTAR UK HOLDINGS LIMITED, Keighley (GB)

(72) Inventors: David Burton, Skipton (GB); Martyn Ward, Bingley (GB)

(21) Appl. No.: 14/476,377

(22) Filed: Sep. 3, 2014

(51) Int. Cl. G08C 17/02

(52) U.S. Cl. CPC G08C 17/02; G08C 2201/30; G08C 2201/92; G08C 2201/93

(57) ABSTRACT

Various arrangements for presenting contextual menus are presented. A mobile device may be configured to provide contextual menus for control or monitoring of components. Different menus and interfaces are presented based the position of the mobile device or objects being pointed at using the mobile device. Specific objects may be designated as control markers. The objects may be recognized using a camera of the mobile device. When a control marker is recognized a specific menu or interface that is associated with the control marker may be presented to the user.

### BACKGROUND

Control and monitoring systems for homes are typically designed for a limited and specific control or monitoring function. The systems are often difficult to manage and configure and rely on proprietary non-intuitive interfaces and/or keypads. Users wishing to deploy different control and monitoring tasks in their home are forced to deploy multiple inoperable systems each designed for a specific task and each with a separate control and configuration interface. Improved home control and monitoring systems are needed.

### SUMMARY

In embodiments, a method for automation control using a mobile device is presented. The method includes the steps of determining a relative position of the mobile device in relation to a designated house-hold object. Based at least in part on the relative position of the mobile device, determining if the mobile device is pointing at the designated house-hold object. The method further includes the steps of providing an indication that the mobile device is pointing at the designated house-hold object, determining a component associated with the designated house-hold object, and providing a user interface on the mobile device for interacting with the component associated with the designated house-hold object. In embodiments the user interface includes features specific to the component.

In embodiments, the method may further include the steps of establishing a communication channel with the component, receiving, via the communication channel, data related to a state of the component, and transmitting, via the communication channel, a control command to the component. In some embodiments the steps may also include determining a change in the relative position of the mobile device, determining if the mobile device is pointing at a second designated house-hold object associated with a second component, and modifying the user interface on the mobile device for interacting with the second component associated with the second designated house-hold object. In some embodiments the position may include an orientation and a location of the mobile device. In some cases the designated house-hold object may be selected from a group consisting of a computer readable image, a home automation component, and a location in a home. The method may also include capturing an image from a camera of the mobile device and analyzing the image to identify the designated house-hold object. In some embodiments determining the relative position of the mobile device may include the steps of receiving data from a sensor attached to the mobile device and tracking movement of the mobile device by analyzing changes in data from the sensor.

In some embodiments, a non-transitory processor-readable medium for automation control using a mobile device is presented. The medium may include processor-readable instructions configured to cause one or more processors to determine a relative position of the mobile device in relation to a designated house-hold object. Based at least in part on the relative position of the mobile device, determine if the mobile device is pointing at the designated house-hold object. In embodiments the medium may include instruction configured to cause one or more processors to provide an indication that the mobile device is pointing at the designated house-hold object, determine a component associated with the designated house-hold object, and provide a user interface on the mobile device for interacting with the component associated with the designated house-hold object. In some embodiments, the user interface includes features specific to the component.

In some embodiments, a mobile device configured for automation control is presented. The mobile device may include one or more processors and a memory communicatively coupled with and readable by the one or more processors and having stored therein processor-readable instructions which, when executed by the one or more processors, cause the one or more processors to determine a relative position of the mobile device in relation to a designated house-hold object. Based at least in part on the relative position of the mobile device, the mobile device may determine if the mobile device is pointing at the designated house-hold object. In embodiments, the instructions which, when executed by the one or more processors, may cause the one or more processor to also provide an indication that the mobile device is pointing at the designated house-hold object, determine a component associated with the designated house-hold object, and provide a user interface on the mobile device for interacting with the component associated with the designated house-hold object. In embodiments the user interface may include features specific to the component.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A and 1B illustrate embodiments of a control interface in a home environment.

FIG. 2 illustrates an interface for detecting control markers using a mobile device.

FIG. 3 illustrates an embodiment of a home monitoring and control system.

FIG. 4 illustrates an embodiment of a contextual interface engine.

FIG. 5 illustrates an embodiment of a method for automation control using a mobile device.

FIG. 6 illustrates another embodiment of a method for automation control using a mobile device.

FIG. 7 illustrates an embodiment of a method for training a mobile device for automation control.

FIG. 8 illustrates an embodiment of a method for training a mobile device for automation control.

FIG. 9 illustrates an embodiment of a computer system.

### DETAILED DESCRIPTION

Components of a home automation system may be controlled using a mobile device such as a remote control, mobile phone, or tablet computer. A mobile device may be configured to provide an interface for control or monitoring for the components of a home automation system. An interface on a mobile device may allow a user to receive the status of a component or adjust the operating parameters of the component. A mobile device may be configured to send and receive data to components of a home automation system.

A mobile device may be configured to control or monitor various components or aspects of a home automation system. A mobile device, for example, may be configured to communicate with a thermostat of a home and adjust the temperature of a home. The same device may be configured to monitor or view video images of a security camera installed in a home. Further still, the same mobile device may also be used to determine the status of a smoke alarm or to control the position of window blinds.

The control of each component or function of a home automation system may require a different user interface and control characteristics such as control protocols, communication protocols, authorization, and the like. A user interface and/or control characteristics may be automatically selected by the mobile device when the device is in proximity of a component of the home automation system. In some embodiments, a user interface and/or control characteristics may be automatically selected by the mobile device when the mobile device is pointed at a control marker associated with a component of the system.

A mobile device may be configured to detect when the mobile device is being pointed at a home automation component. A mobile device may be configured to detect one or more control markers. The control markers may be associated with one or more components of a home automation system. When a control marker is detected by the mobile device, the mobile device may be configured to provide a user interface on the mobile device that allows a user to view data received from the component or control aspects of the component.

A control markers may include a variety of images, signals, or objects that may be detected and identified by a mobile device. In some embodiments, a control marker may be a specific position or gesture of a mobile device. A control marker may be detected by a sensor of the mobile device. Control markers may be detected using accelerometers, cameras, microphones, or other sensors of a mobile device.

In one example, a mobile device may be configured to capture images or video from a camera of a mobile device. Images may be analyzed to recognize objects designated as control markers. Objects my household objects that are associated to components of a home automation system. When a house hold item that is designated as a control marker is detected in an image captured by a camera, the mobile device may determine the component that is associated with the control marker. The mobile device may determine the capabilities, restrictions, communication protocols, and the like of the component and may provide an interface for interacting with the component. The mobile device may receive and/or transmit data to the component.

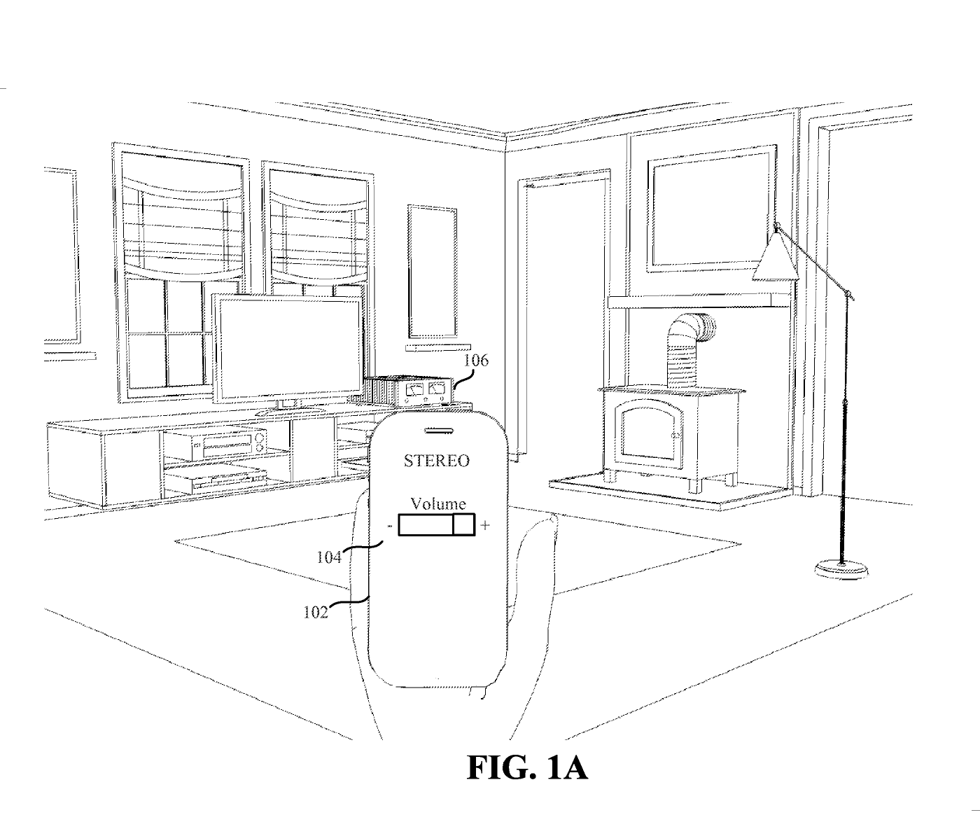

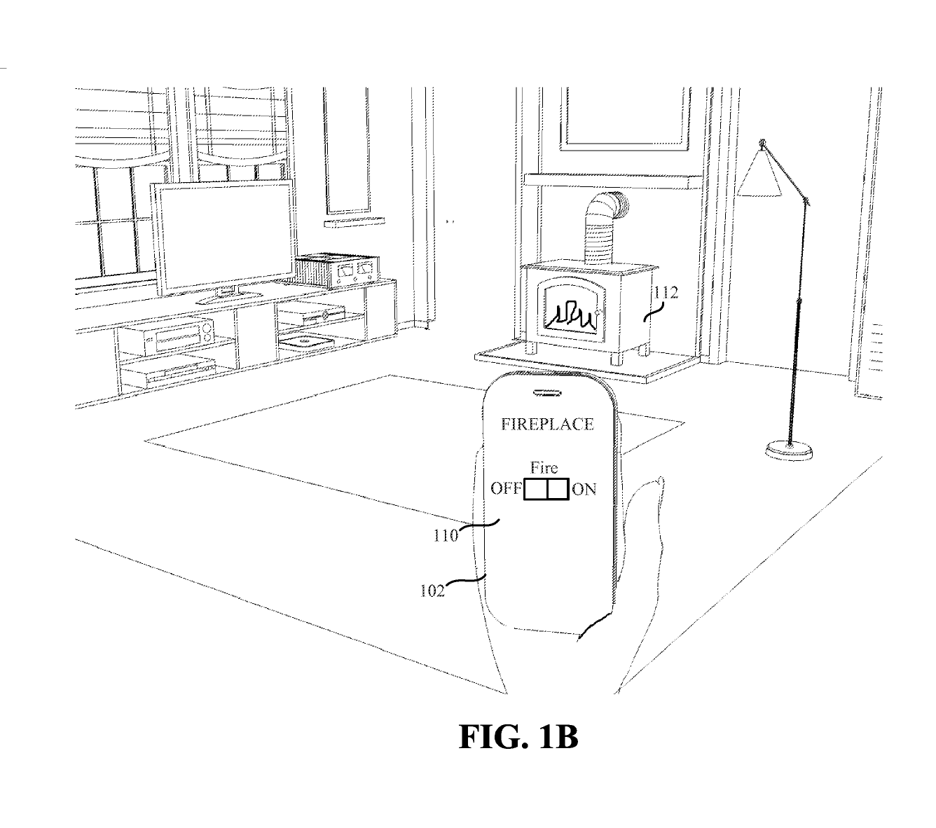

For example, FIG. 1A shows an embodiment with a mobile device. The mobile device 102 may be a handheld smart phone for example. The mobile device 102 may include a front facing camera. The camera may be used to scan or take images and/or video of the surroundings or areas that the user is pointing the mobile device at. When a user points the camera of the mobile device 102 at an area of a home, the mobile device may analyze the images captured by the camera to determine if there are any control markers in the field of view of the camera. The mobile device may be configured or trained by the user to detect specific objects designated as control markers. In some cases, the mobile device may be preprogrammed to detect or recognize specific patterns, objects, logos, or other items. In the example of FIG. 1A, a stereo 106 may be a control marker. The mobile device 102 may be configured to recognize the shape of the stereo 106. The mobile device may use image recognition algorithms and software to identify patterns of the image that match the shape and characteristics of the stereo 106.

When a control object is detected, the mobile device may determine which component of a home automation system is associated with the control marker. The association between a control marker and a component may be defined by a user. The mobile device may store a table or other data structures that associates control markers with components. The table may include definitions and characteristics of the components that may include the capabilities of the components, authorization requirements, communication protocols, user interface specifications, and the like. When a control marker is detected the mobile device may use the table to determine the associated component and the characteristics of the component. In this example, the control marker may be associated with the home audio system of the home. The mobile device may include information about the characteristics of the home audio system. The characteristics may include how to connect to the home audio system, which protocols are necessary, the capabilities, the user interface to present to the user, and the like. The characteristics of the home audio system may be loaded by the mobile device and the user interface 104 on the mobile device 102 may be displayed for controlling the home audio system. Controls on the interface may include controls for changing the volume, for example. When the user changes the setting of the control, the mobile device may transmit a command to the home audio system to adjust the volume.

The mobile device may be configured to detect or recognize many different control markers and automatically, upon detection of a control marker, provide a user interface for the component associated with the control marker. For example, as shown in FIG. 1B, when the mobile device 102 is pointed at a different location of the home another control marker may be detected. The mobile device may be configured to detect the image of a fireplace 112. The fireplace may be a control marker associated with the gas heater of the home. When the fireplace 112 control marker is detected by the camera, the mobile device 102 may identify the characteristics of the gas heater and provide to the user an interface 110 on the mobile device 102 for controlling the gas heater. The interface may, for example allow the user to turn the gas heater on or off.

A user may therefore control or interact with many different components of a home automation system by pointing a mobile device at control markers. Detection of control markers may cause the mobile device to automatically determine the capabilities and characteristics of the component and provide a user with an interface for the components. A user does not have to navigate menus or search for components and interfaces to control or interact with components. Pointing a mobile device at control markers may automatically provide the necessary interfaces.

Users may design or modify custom control interfaces for components. User may select the operations, actions, buttons, colors, images, skins, layout, fonts, notifications, and the like for the interfaces for the components. In some cases users may limit or arrange the user interface to show a subset of a the data or controls associated with a component. For example, a stereo system may include functions related to controlling the audio properties such as the bass, treble, and equalizer functions. The stereo may have functions for selecting of scanning radio stations, changing discs, navigating to internet locations. A user however, may only choose a subset of the functions for an interface. A user may select functions and controls for adjusting the volume of the stereo and turning the stereo ON or OFF. A design application or interface may be provided to a user allowing the user to select a subset of features and controls for each component and adjust other characteristics of the interface.

In some embodiments user may save their interface designs and share with other users. User designs for interfaces for components may be uploaded to a service provided, a cloud, a repository, or the like. Other users may be able to download and use the interface designs for interfaces for components.

In the examples of FIGS. 1A and 1B, the control markers (stereo 106, fireplace 112) are also the components of the home automation system. In many cases the control marker may be a different object than the component. For example, a control marker such as a window of a home may be associated with the heating and cooling components of the home. In another example, a picture or a barcode on a wall may be associated with the home security system.

In some cases, control markers may be in a different part of the home and may be seemingly unrelated to the component or device the control marker is associated with. Users may designate virtually an object, location, or gesture of a component. A camera facing down towards the a control marker in a corner of the room, for example, may be associated with components in a different room or location. In embodiments control markers may be spread around a room to allow mapping and multiple markers could be used to locate or may be associated with one component or device.

In some embodiments, the mobile device may automatically associate specific control markers such as logos or patterns with specific components. The mobile device may include a database or other data structure that identifies specific manufacturer logos, patterns, or the like with components. When a specific manufacturer logo is detected, the mobile device may be configured to automatically determine the component associated with the logo and provide a user interface for interacting with the component.

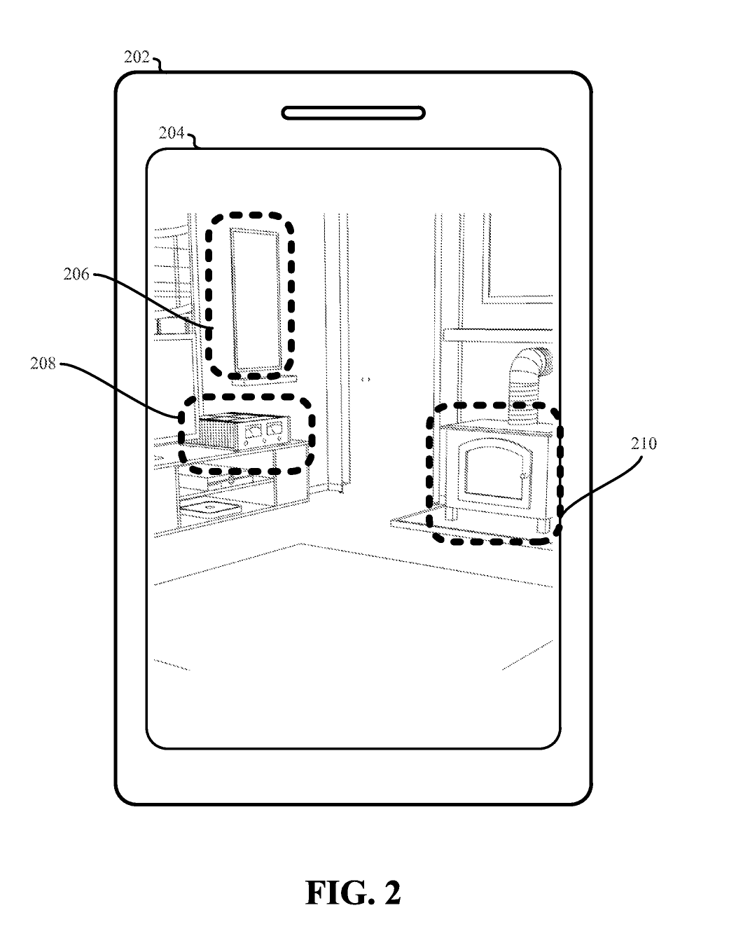

In some cases, the mobile device may be configured to provide an indication when a control marker is detected. In some cases more than one control marker may be in the field of view of the camera of the mobile device or control markers may be in close proximity making it difficult to determine which control marker the mobile device is pointing at. The mobile device may provide an interface that may provide an indication when a control marker is detected and allow the user to select one of the control markers. For example FIG. 2 shows one embodiment of an interface for identifying and/or detecting control markers using a mobile device. A mobile device 202 that uses a camera may display on the screen of the device an image or real time video of the images captured by the camera. Control markers that are detected in the images may be highlighted or outlined. As shown in FIG. 2, for example, three control markers are within the field of view of the camera of the mobile device 202. The three control markers that include the stereo 208, fireplace 210, and the window 206 may be highlighted. In some cases an option identification describing the functionality or component associated with the control marker may be displayed. Text or icon may be displayed next to each highlighted control marker that is indicative of their functionality.

The interface on the mobile device may be configured to allow a user to select or acknowledge a control marker. Upon selection of an identified control marker, the mobile device may present an interface specific for the component associated with the control marker. The control marker indication may be used by a user to discover controllable components in their home. A mobile device may be used to scan an area to discover control markers.

In some embodiments, when more than one control marker is in the field of view of the camera of the mobile device, the mobile device may provide an indication of the control markers. Users may select one of the control markers by focusing on one specific control marker. A user may select one of the control markers by positioning the mobile device towards the desired control marker. For example, in the case of a mobile device with a camera, a control marker may be selected by a user by positioning the mobile device such that the desired control marker is in the center of the field of view of the camera. After predefined time period, say two or three seconds, the control marker in the center of the field of view of the camera may be automatically selected and the user interface for the control marker may be displayed to the user.

In some configurations, the mobile device may be “trained” by a user to detect or recognize control markers. The trained control marker may then be associated with a component. A user may use a mobile device to capture and identify images of items or areas in a home. The mobile device may store the images or analyze the images to create templates that may be used to identify the control marker in subsequent images.

Components in a home automation system may advertise themselves, their capabilities, and/or their associated control markers to mobile devices. Mobile devices may use a discovery mode or other procedures to detect nearby or available components. The components may provide to the mobile device their characteristics, control interfaces, and or control marker templates and definitions that may be used to detected the control markers.

In embodiments, detection of control markers may be based only on the analysis of images captured by a mobile device. In some cases the detection of control markers may be supplemented with position information. Position information may include the location and/or the orientation of the mobile device. Position information may be determined from sensors of the mobile device such as GPS sensors, accelerometers, or gyroscopes. In some cases, position information may be external sensors or detectors and transmitted to the mobile device. Sensors in a home, for example, may detect the presence of the mobile device and track the location of the device through the home. The position data may be transmitted to the device. Position information may be used to narrow down or filter the number of possible control marker definitions that are used in the analysis of an image captured by the camera of the mobile device. For example, a mobile device may be determined to be located in a bedroom of a home. Based on the position, the control markers that are known to be located in the kitchen or the living room of a home may be ignored and only control marker definitions that are known to be located in the bedroom may be a analyzed.

In some embodiments the location of control markers may be based only on the position information. A control marker may be the specific position of a mobile device. Based on the position (location and/or orientation), the location or control marker within the home the mobile device is pointing at can be determined.

In some embodiments, markers or objects may be used to aid in navigation or location detection. Location markers may not be associated with components or devices but may be associated with predefined locations. Location markers may be detected by sensors, such as a camera, of the mobile device. The detection of location marker may provide an indication to the mobile device as to the location of the mobile device. Control markers may be identified relative to the location markers. Location markers may in some cases also be control markers. A mobile device may map a location such as a room by using location and control markers. A map of the room with locations of the control and location markers may provide location feedback to the mobile device as the mobile device is moved and repositioned around the room.

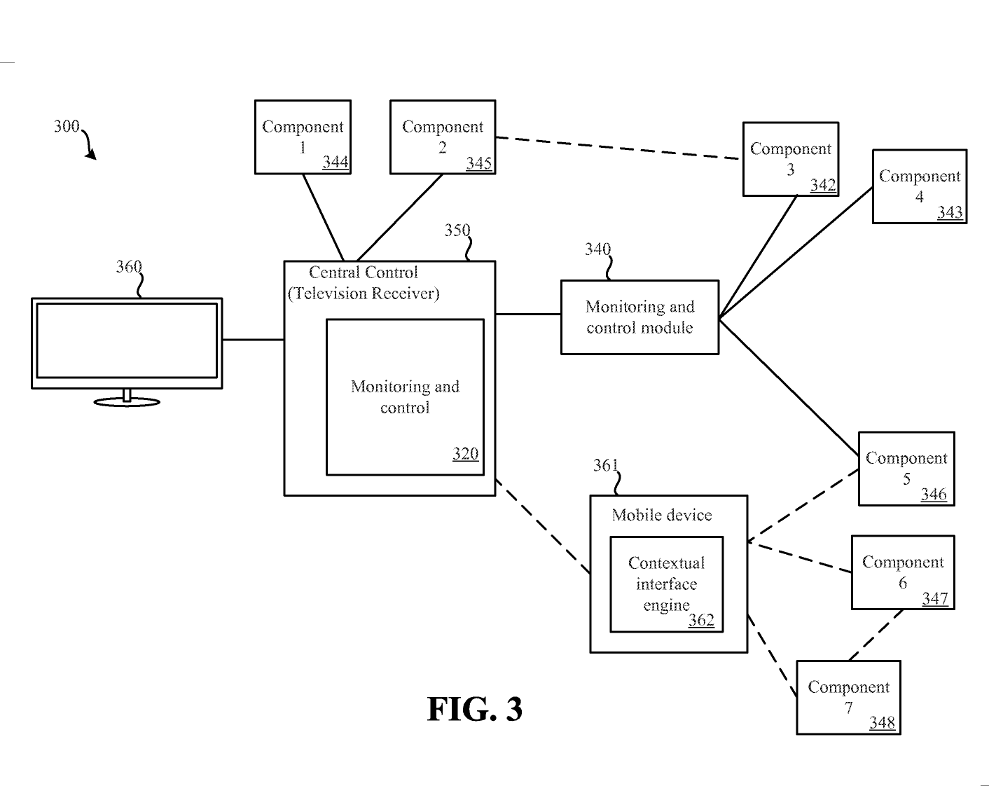

FIG. 3 shows an embodiment of a system 300 for home monitoring and control. The system 300, may include various components 342, 343, 344, 345, 346, 347, 348 that may include sensing and/or control functionalities. The components 342, 343, 344, 345, 346, 347, 348 may be spread throughout a home or a property. Some components 342, 345 may be directly connected to a central control 350. Some components 342, 343, 346 may connect to a central control 350 via separate control and monitoring modules 340. Other components 347, 348 may be independent from a central control 350.

A central control 350 in a home may provide for a control interface to monitor/control one or more of the components. In some embodiments, the central control 350 may be a television receiver. The television receiver may be communicatively coupled to receive readings from one or more components that may be sensors or control modules of the system.

Television receivers such as set-top boxes, satellite based television systems, and/or the like are often centrally located within a home. Television receivers are often interconnected to remote service providers, have wired or wireless interconnectivity with mobile devices, provide a familiar interface and are associated or connected with a large display that may be used displaying status and control functions.

Television receivers may be configured to receive information from sensors, telemetry equipment, and other systems in a home. Capabilities of the television receivers may be utilized to analyze sensor and telemetry readings, receive user input or configurations, provide visual representations and analysis of sensor readings and the like. For example, the processing and data storage capabilities of the television receivers may be used to analyze and process sensor readings. The sensor readings may be stored on the data storage of the receiver providing historical data for analysis and interpretation.

A central control 350 may include a monitoring and control module 320 and may be directly connected or coupled to one or more components. Components may be wired or wirelessly coupled to the central control 350. Components may be connected in a serial, parallel, star, hierarchical, and/or the like topologies and may communicate to the central control via one or more serial, bus, or wireless protocols and technologies which may include, for example, WiFi, CAN bus, Bluetooth, I2C bus, ZigBee, Z-Wave and/or the like.

In some embodiments, the system may include one or more monitoring and control modules 340 that are external to the central control 350. In embodiments the central control may interface to components via one or more monitoring and control modules 340.

Components of the system may include sensors. The sensors may include any number of temperate, humidity, sound, proximity, field, electromagnetic, magnetic sensors, cameras, infrared detectors, motion sensors, pressure sensors, smoke sensors, fire sensors, water sensors, and/or the like. Components of the system may include control units. The control units may include any number of switches, solenoids, solid state devices and/or the like for making noise, turning on/off electronics, heating and cooling elements, controlling appliances, HVAC systems, lights, and/or the like. For example, a control unit may be a device that plugs in to an electrical outlet of a home. Other devices, such as an appliance, may be plugged into the device. The device may be controlled remotely to enable or disable electricity to flow to the appliance.

In embodiments, sensors may be part of other devices and/or systems. For example, temperature sensors may be part of a heating and ventilation system of a home. The readings of the sensors may be accessed via a communication interface of the heating and ventilation system. Control units may also be part of other devices and/or systems. A control unit may be part of an appliance, heating or cooling system, and/or other electric or electronic device. In embodiments the control units of other system may be controlled via a communication or control interface of the system. For example, the water heater temperature setting may be configurable and/or controlled via a communication interface of the water heater or home furnace. Sensors and/or control units may be combined into assemblies or units with multiple sensing capabilities and/or control capabilities. A single module may include, for example a temperature sensor and humidity sensor. Another module may include a light sensor and power or control unit and so on.

Components such as sensors and control units may be configurable or adjustable. In some cases the sensors and control units may be configurable or adjustable for specific applications. The sensors and control units may be adjustable by mechanical or manual means. In some cases the sensors and control units may be electronically adjustable from commands or instructions sent to the sensors or control units.

In embodiments, the results, status, analysis, and configuration data details for each component may be communicated to a user. In embodiments auditory, visual, and tactile communication methods may be used. In some cases a display device such as a television 360 may be used for display and audio purposes. The display device may show information related to the monitoring and control application. Statistics, status, configuration data, and other elements may be shown.

In embodiments the system may include additional notification and display devices such as a mobile device 361 capable of notifying the user, showing the status, configuration data, and/or the like. The additional notification and display devices may be devices that directly or indirectly connected to the central control 350. In some embodiments computers, mobile devices, phones, tablets, and the like may receive information, notifications, from the central control 350. Data related to the monitoring and control applications and activity may be transmitted to mobile devices and displayed to a user via the central control or directly from components.

A mobile device 361 may present to the user, interfaces that may be used to configure or monitor or interact with system components. An interface may include one or more options, selection tools, navigation tools for modifying the configuration data which in turn may change monitoring and/or control activity of components.

A contextual interface engine 362 of a mobile device 361 may be used to detect control markers that may trigger the display of specific interfaces for the control or monitoring of components that may be associated with the control marker. Depending on the component or configuration of the system 300, the mobile device may transmit and/or receive data and commands related to the component directly from each component or via a central control 350. In some configurations, the central control may provide a uniform interface for various components.

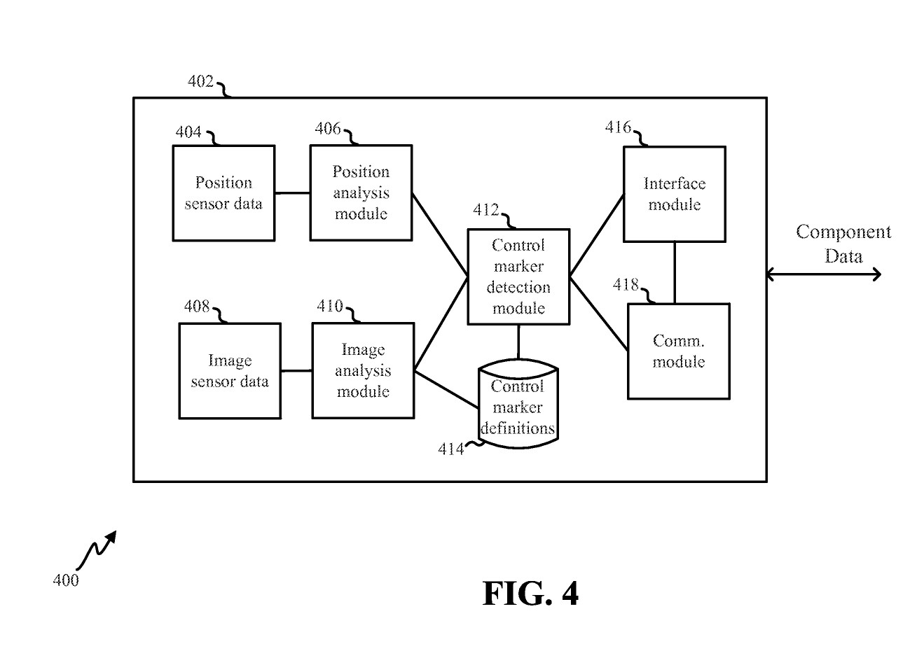

FIG. 4 illustrates an embodiment of a contextual interface engine 400. Contextual interface engine 400 represents an embodiment of contextual interface engine 362 of FIG. 3. Contextual interface engine 400 is illustrated as being composed of multiple components. It should be understood that contextual interface engine 400 may be broken into a greater number of components or collapsed into fewer components. Each component of the contextual interface engine 400 may include computerized hardware, software, and/or firmware. In some embodiments, contextual interface engine 400 is implemented as software that is executed by a processor of the mobile device 361 of FIG. 3. Contextual interface engine 400 may include a position analysis module 406 that receives position sensor data 404, an image analysis module 410 that received image sensor data 408. The contextual interface engine 400 may also include a control marker detection module 412 and control marker definitions 414 as well as an interface module 416 and a communication module 418.

The contextual interface engine 400 may analyze sensor data to determine if a mobile device is being pointed at or is in proximity to a control marker. Based on the identified control marker, the contextual interface engine 400 may determine the component(s) associated with the control marker and provide an interface for the component. The contextual interface engine may access sensor data such as position sensor data 404 or image sensor data 408 of a mobile device or from an external source. The position sensor data 404, for example, may be received from a position tracking system in a home that tracks the location of a user or a mobile device. Sensor data may also originate from cameras, infrared sensors, accelerometers, compass, lasers, and the like that may be part of a mobile device. In some embodiments, only one of position sensor data or image sensor data may be available.

Image sensor data 408 may be processed and analyzed by the image analysis module 410. The image analysis module 410 may be configured to analyze image data and identify possible control markers. The image analysis module may use image recognition algorithms to identify features of the image. The image analysis module may perform multiple passes of analysis to identify different types of control markers. In the first pass, the image analysis module 410 may be configured to identify computer readable barcodes or other computer readable identifiers. In subsequent passes the image analysis module may identify objects or shapes that may be control markers. The image analysis module 410 may receive control marker definitions from the control marker definitions database 414. The definitions may include characteristics of markers that may be used for image analysis. The image analysis module 410 may compare the definitions against features identified in the image to determine if any of the definitions are consistent with the image.

Position sensor data 404 may be processed and analyzed by the position analysis module 406. Position data that may include location and/or orientation of the mobile device. The position data may be analyzed by the position analysis module 406 to map the position data to specific area of a home. The position analysis module may use the location and orientation data to determine specific areas of a home that a mobile device is pointing at.

The control marker detection module 412 may use the analysis of the position analysis module 406 and/or the image analysis module 410 to identify control markers that may be in close proximity or that may be pointed at by the mobile device. The control marker detection module may refine the identified control markers from the image analysis module 410 using the position data from the position analysis module 406. Control markers that are not consistent with the position of the mobile device may be filtered or ignored. Data associated with the control markers that are identified to be consistent with the image sensor data and the position may be loaded from the control marker definitions database 414 or from an external source. The data may include information about the component(s) associated with the control markers, the capabilities of the components, authorization required for the components, communication protocols, user interface data, and the like. The control marker detection module 412 may be configured to further determine that of the user or mobile device is compatible and/or authorized to interact with the component(s) associated with the control markers.

Based on the identified control markers by the control marker detection module 412, the interface module 416 may be configured to provide an interface that may be displayed by the mobile device for displaying data related to the components associated with the control markers. In some cases the interface may be configured to receive input from a user to adjust the operating characteristics or settings of the component. The communication module 418 may establish communication with the component(s). The communication may be direct with each component or via other components or central control. Component data received by the communication module 418 may be displayed on the user interface.

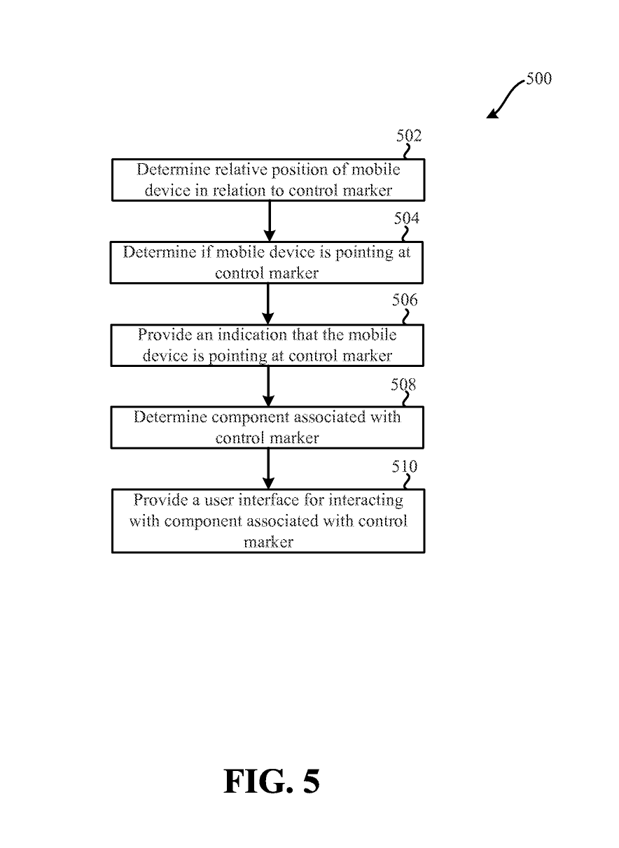

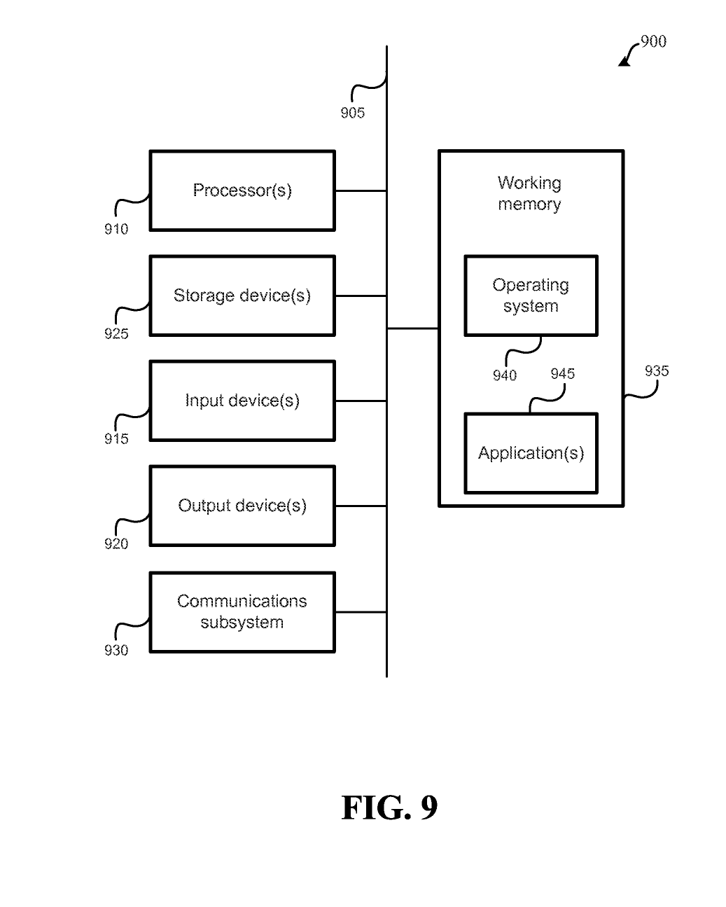

Various methods may be performed using system 300 of FIG. 3 and the contextual interface engine 400 of FIG. 4. FIG. 5 illustrates an embodiment of a method 500 for performing automation control using a mobile device. Each step of method 500 may be performed by a computer system, such as computer system 900 of FIG. 9. Means for performing the method 500 can include one or more computing devices functioning in concert, such as in a distributed computing arrangement.

At step 502 the relative position of a mobile device in relation to a control marker may be determined. Data from sensors of the mobile device or from external systems may be used to determine the location and/or orientation of a mobile device. Data related to the position of known control markers may be compared to the position of the mobile device to determine their relative locations. In some cases, location markers may be detected and used to determine the location. At step 504, a determination may be made if the mobile device is pointing at a control marker. The relative positions and orientations of the mobile device and the control markers may be analyzed for the determination. In some cases, additional data may be used to verify that the mobile device is pointing at the control marker. Images from a camera or other sensors may be captured and used to determine the relative locations of the mobile device and the control markers.

At step 506, an indication may be generated that that the mobile device is pointing at a control marker. The indication may include a visual, auditory, and/or tactile indication. At step 508, the component(s) associated with the control marker may be determined. A mobile device may query one or more internal or external databases or resources to determine the capabilities, available settings, user preferences, and the like that are related to the component(s). At step 510 a user interface may be provided to the user that is configured for the component(s) associated with the control marker that the mobile device is pointing at. The user interface may present information related to the component such current settings, sensor readings, and the like. The user interface may present controls for modifying settings of the component.

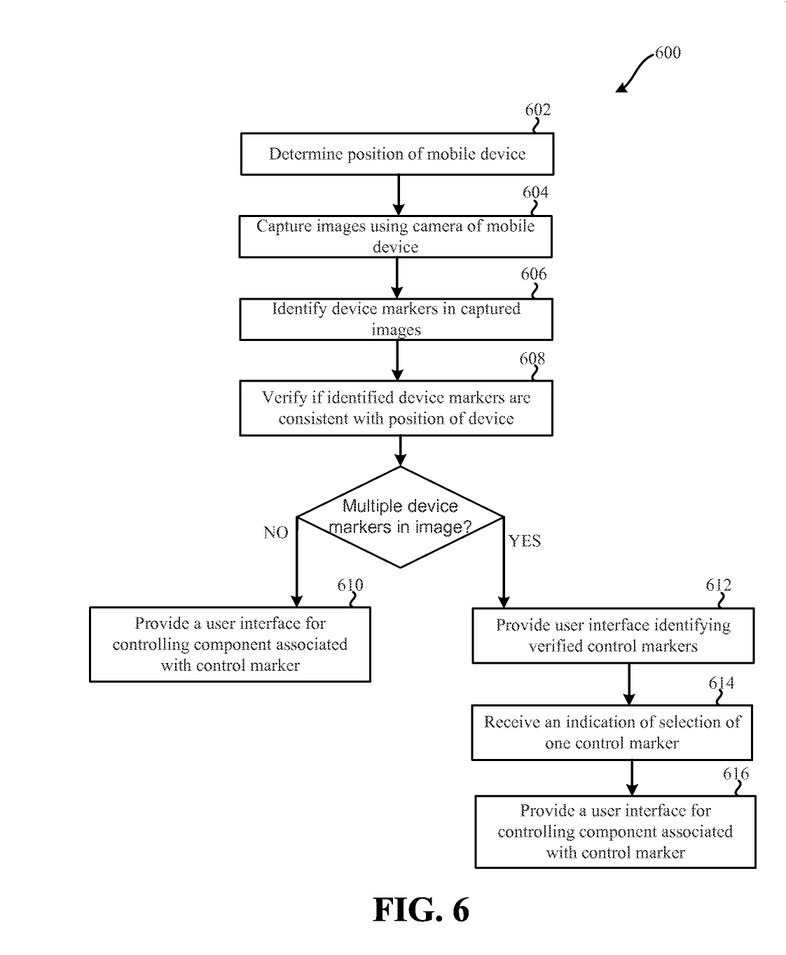

FIG. 6 illustrates an embodiment of another method 600 for performing automation control using a mobile device. Each step of method 600 may be performed by a computer system, such as computer system 900 of FIG. 9. Means for performing the method 600 can include one or more computing devices functioning in concert, such as in a distributed computing arrangement.

At step 602 the position of a mobile device may be determined. Data from sensors of the mobile device or from external systems may be used to determine the position and/or orientation of a mobile device. At step 604, images or video from a camera of the mobile device may be captured. The images and/or video may be analyzed to identify control markers. At step 606 the identified control markers may be compared with the locations of known control markers to determine if the identified control markers are consistent with the position of the mobile device. If one or more identified control marker are not consistent with the position of the mobile device the images and/or the position of the mobile device may be further refined by analyzing sensor readings.

If only one control marker is identified, at step 610, the mobile device may present to a user a user interface for a component associated with the control marker. If more than one control marker is identified, at step 612, the mobile device may present a user interface that shows all the identified control markers and optionally the components associated with each control marker. The user interface may allow the user to select one of the control markers. After an indication of a selection of one control marker is received from the user in step 614, the mobile device may be configured to provide an interface for a component associated with the selected control marker.

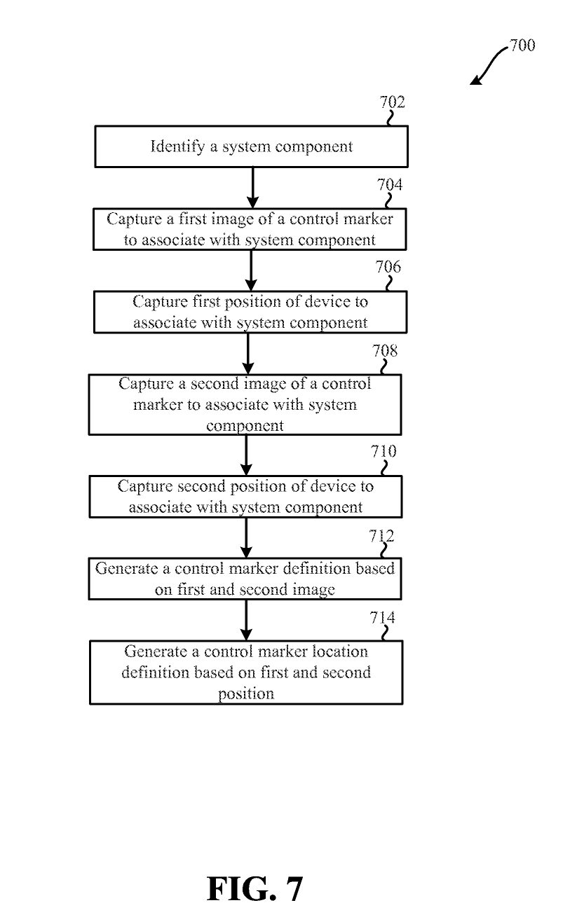

FIG. 7 illustrates an embodiment of a method 700 for training a mobile device for automation control. Each step of method 700 may be performed by a computer system, such as computer system 900 of FIG. 9. Means for performing the method 700 can include one or more computing devices functioning in concert, such as in a distributed computing arrangement. The method may be used to train a mobile device to detect a user specified control marker. The control marker may be associated with a component that may then be controlled by the mobile device.

At step 702 a component of a home automation system may be identified. The component may be selected from the mobile device. The mobile device may be used to search of a wireless signal for components. The mobile device may provide a list of available components that may be associated with a control marker. The mobile device may also query a central control to identify components. An object in a home may be selected as a control marker for the component. When the a mobile device is pointing at the object an interface for the component may be provided on the mobile device. To capture and define the control marker the mobile device may be used to capture an image of the object that is designated as the control marker in step 704. The camera of the mobile device may be used to capture a picture or a video clip of the the object. At the same time or around the same time as the image of video of the object is captured, the mobile device may also capture the position information of the device in step 706. The position information and the image may be associated with each other. The capturing of the image and the position may be performed from a location that a user would normally try to detect the control marker.

Additional images and position information may be captured of the object using the mobile device in steps 708 and 710. The additional images and position information may be captured from different angles, different positions, in different lighting conditions, and the like. The captured images of the object may be analyzed to identify shapes, or definitions that may be later used to identify the marker. In some cases, the user may identify a specific area of an image that includes the object to be used as the control marker. In some embodiments, the images may include machine readable markers such as barcodes, codes, shapes, or the like that may be positioned on an object during image capture that will facilitate object detection.

The captured position information may be associated with the control marker definitions. The position information may be combined to provide a zone or range of valid mobile device positions in step 714. The position information and the image definitions may be used to identify a control marker during system operation.

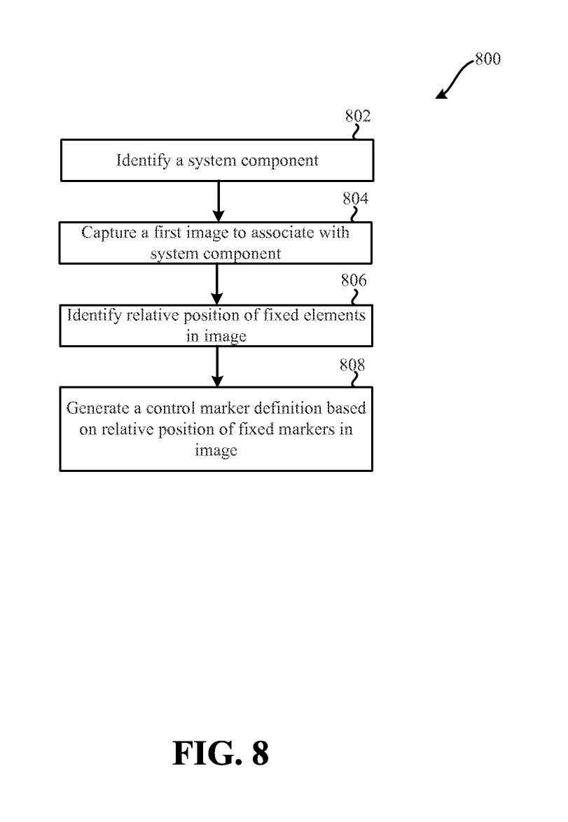

FIG. 8 illustrates an embodiment of a second method 800 for training a mobile device for automation control. Each step of method 800 may be performed by a computer system, such as computer system 900 of FIG. 9. Means for performing the method 800 can include one or more computing devices functioning in concert, such as in a distributed computing arrangement.

At step 802 a component of a home automation system may be identified. The component may be selected from the mobile device. In embodiments a control marker may be created by positioning elements that may be easily detectable by a camera. Elements may be for example, stickers or colored stamps with shapes such as circles, triangles, or other shapes. The elements may be not visible by a human eye but only visible by a camera due to their color, for example. One or more elements may be positioned to create a control marker. The control marker may be defined by the number of elements, types of elements, relative orientation of the elements, and the like. A camera of the mobile device may be used to capture an image of the elements at step 804. At step 806 the relative position, the types of elements, the number of elements in the image may be analyzed to generate a control marker definition in step 808.

It should be understood that although the methods and examples described herein used a home automation system other environments may also benefit from the methods and systems described. A mobile device may be used to provide contextual menus for interacting with components in industrial settings for example. The status of sensors, machines, structures, or systems may be updated or controlled in a factory or warehouse with a mobile device. The menus and interfaces of the mobile device may change depending on the objects or control markers the mobile device is pointing at.

A computer system as illustrated in FIG. 9 may be incorporated as part of the previously described computerized devices, such as the described mobile devices and home automation systems. FIG. 9 provides a schematic illustration of one embodiment of a computer system 900 that can perform various steps of the methods provided by various embodiments. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computer system 900 is shown comprising hardware elements that can be electrically coupled via a bus 905 (or may otherwise be in communication, as appropriate). The hardware elements may include one or more processors 910, including without limitation one or more general-purpose processors and/or one or more special-purpose processors (such as digital signal processing chips, graphics acceleration processors, video decoders, and/or the like); one or more input devices 915, which can include without limitation a mouse, a keyboard, remote control, and/or the like; and one or more output devices 920, which can include without limitation a display device, a printer, and/or the like.

The computer system 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 900 might also include a communications subsystem 930, which can include without limitation a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. The communications subsystem 930 may permit data to be exchanged with a network (such as the network described below, to name one example), other computer systems, and/or any other devices described herein. In many embodiments, the computer system 900 will further comprise a working memory 935, which can include a RAM or ROM device, as described above.

The computer system 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 925 described above. In some cases, the storage medium might be incorporated within a computer system, such as computer system 900. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 900) to perform methods in accordance with various embodiments of the invention. According to a set of embodiments, some or all of the procedures of such methods are performed by the computer system 900 in response to processor 910 executing one or more sequences of one or more instructions (which might be incorporated into the operating system 940 and/or other code, such as an application program 945) contained in the working memory 935. Such instructions may be read into the working memory 935 from another computer-readable medium, such as one or more of the non-transitory storage device(s) 925. Merely by way of example, execution of the sequences of instructions contained in the working memory 935 might cause the processor(s) 910 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 900, various computer-readable media might be involved in providing instructions/code to processor(s) 910 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 925. Volatile media include, without limitation, dynamic memory, such as the working memory 935.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900.

The communications subsystem 930 (and/or components thereof) generally will receive signals, and the bus 905 then might carry the signals (and/or the data, instructions, etc. carried by the signals) to the working memory 935, from which the processor(s) 910 retrieves and executes the instructions. The instructions received by the working memory 935 may optionally be stored on a non-transitory storage device 925 either before or after execution by the processor(s) 910.

It should further be understood that the components of computer system 900 can be distributed across a network. For example, some processing may be performed in one location using a first processor while other processing may be performed by another processor remote from the first processor. Other components of computer system 900 may be similarly distributed. As such, computer system 900 may be interpreted as a distributed computing system that performs processing in multiple locations. In some instances, computer system 900 may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for automation control using a mobile device, comprising:
determining a relative position of the mobile device in relation to a designated house-hold object;
based at least in part on the relative position of the mobile device, determining if the mobile device is pointing at the designated house-hold object;
providing an indication that the mobile device is pointing at the designated house-hold object;
determining a component associated with the designated house-hold object; and
providing a user interface on the mobile device for interacting with the component associated with the designated house-hold object;
wherein the user interface includes features specific to the component.

2. The method of claim 1, further comprising:
establishing a communication channel with the component;
receiving, via the communication channel, data related to a state of the component; and
transmitting, via the communication channel, a control command to the component.

3. The method of claim 1, further comprising:
determining a change in the relative position of the mobile device;
determining if the mobile device is pointing at a second designated house-hold object associated with a second component; and
modifying the user interface on the mobile device for interacting with the second component associated with the second designated house-hold object.

4. The method of claim 1, wherein position includes an orientation and a location of the mobile device.

5. The method of claim 1, wherein the designated house-hold object is selected from a computer readable image, a home automation component, and a location in a home.

6. The method of claim 1, wherein determining if the mobile device is pointing at the designated house-hold object comprises:
capturing an image from a camera of the mobile device; and
analyzing the image to identify the designated house-hold object.

7. The method of claim 1, wherein determining the relative position of the mobile device comprises:
receiving data from a sensor attached to the mobile device; and
tracking movement of the mobile device by analyzing changes in data from the sensor.

8. A non-transitory processor-readable medium for automation control using a mobile device, the medium comprising processor-readable instructions configured to cause one or more processors to:
determine a relative position of the mobile device in relation to a designated house-hold object;
based at least in part on the relative position of the mobile device, determine if the mobile device is pointing at the designated house-hold object;
provide an indication that the mobile device is pointing at the designated house-hold object;
determine a component associated with the designated house-hold object; and
provide a user interface on the mobile device for interacting with the component associated with the designated house-hold object;
wherein the user interface includes features specific to the component.

9. The non-transitory processor-readable medium of claim 8, wherein the processor-readable instructions cause one or more processors to:
establish a communication channel with the component;
receive, via the communication channel, data related to a state of the component; and
transmit, via the communication channel, a control command to the component.

10. The non-transitory processor-readable medium of claim 8, wherein the processor-readable instructions cause one or more processors to:
determine a change in the relative position of the mobile device;
determine if the mobile device is pointing at a second designated house-hold object associated with a second component; and
modify the user interface on the mobile device for interacting with the second component associated with the second designated house-hold object.

11. The non-transitory processor-readable medium of claim 8, wherein position includes an orientation and a location of the mobile device.

12. The non-transitory processor-readable medium of claim 8, wherein the designated house-hold object is selected from a computer readable image, a home automation component, and a location in a home.

13. The non-transitory processor-readable medium of claim 8, wherein the processor-readable instructions that cause one or more processors to determine if the mobile device is pointing at the designated house-hold object comprise instructions that cause one or more processors to:
capture an image from a camera of the mobile device; and
analyze the image to identify the designated house-hold object.

14. The non-transitory processor-readable medium of claim 8, wherein the processor-readable instructions that cause one or more processors to determine the relative position of the mobile device comprise instructions that cause one or more processors to:
receive data from a sensor attached to the mobile device; and
track movement of the mobile device by analyzing changes in data from the sensor.

15. A mobile device configured for automation control, comprising:
one or more processors;
a memory communicatively coupled with and readable by the one or more processors and having stored therein processor-readable instructions which, when executed by the one or more processors, cause the one or more processors to:
determine a relative position of the mobile device in relation to a designated house-hold object;
based at least in part on the relative position of the mobile device, determine if the mobile device is pointing at the designated house-hold object;
provide an indication that the mobile device is pointing at the designated house-hold object;
determine a component associated with the designated house-hold object; and
provide a user interface on the mobile device for interacting with the component associated with the designated house-hold object;
wherein the user interface includes features specific to the component.

16. The mobile device of claim 15, wherein the processor-readable instructions, when executed, cause the one or more processors to
establish a communication channel with the component;
receive, via the communication channel, data related to a state of the component; and
transmit, via the communication channel, a control command to the component.

17. The mobile device of claim 15, wherein the processor-readable instructions, when executed, cause the one or more processors to
determine a change in the relative position of the mobile device;
determine if the mobile device is pointing at a second designated house-hold object associated with a second component; and
modify the user interface on the mobile device for interacting with the second component associated with the second designated house-hold object.

18. The mobile device of claim 15, wherein position includes an orientation and a location of the mobile device.

19. The mobile device of claim 15, wherein the designated house-hold object is selected from a computer readable image, a home automation component, and a location in a home.

20. The mobile device of claim 15, wherein the processor-readable instructions, when executed, cause the one or more processors to:
capture an image from a camera of the mobile device; and
analyze the image to identify the designated house-hold object.
